(19) United States
(12) Patent Application Publication
(10) Pub. No.: US 2024/0112598 A1
(43) Pub. Date: Apr. 4, 2024

(54) APPARATUS AND METHOD FOR PROVIDING COMPLEX INFORMATION INCLUDING BRAILLE INFORMATION AND VOICE INFORMATION

(71) Applicant: DOT INCORPORATION, Seoul (KR)

(72) Inventors: Ji Ho Kim, Incheon (KR); Ju Yoon KIM, Gwangmyeong-si (KR); Hyeon Cheol Park, Gwangmyeong-si (KR)

(21) Appl. No.: 17/994,315

(22) Filed: Nov. 26, 2022

(30) Foreign Application Priority Data
Sep. 29, 2022 (KR) 10-2022-0124074

(51) Int. Cl. G09B 21/00

(52) U.S. Cl. CPC G09B 21/006; G09B 21/003; G09B 21/007; G09B 21/008

(57) ABSTRACT

Provided are an apparatus and method of providing complex information including braille information and voice information, the method of method of providing complex information including braille information and voice information includes deriving analysis data associated with a reading pattern of a user for braille information, and outputting voice information corresponding to the braille information on the basis of the analysis data.

### CROSS REFERENCE TO RELATED APPLICATION

This application claims priority from and the benefit of Korean Patent Application No. 10-2022-0124074, filed on Sep. 29, 2022, which is hereby incorporated by reference for all purposes as if fully set forth herein.

### BACKGROUND

### Field

The disclosure relates to an apparatus and method for providing complex information including braille information and voice information.

### Discussion of the Background

Due to the recent 4^{th} industrial revolution and the development of IT technology, unmanned devices (e.g., kiosks or the like), which replace conventional workers in providing various information and services, have appeared in large numbers, and the frequency of their use is increasing worldwide. However, since most of the current unmanned devices mainly are produced, disseminated, and operated towards a target of non-disabled users and users of younger age groups, it is hardly difficult for the information vulnerable users, such as disabled users and elderly users, to access and use the services provided by the current unmanned devices.

In this regard, it is expected that the number of disabled people accounts for about 15% of the world's population, reaching 1 billion people worldwide. In addition, considering that the proportion of the disabled people in the total population may be higher in the future, and the adoption of unmanned devices is an inevitable trend that no one can resist due to the lack of service workers, it is expected that information inequality in information vulnerable users, such as the disabled users and the elderly users, continues to intensify and becomes a big social issue.

Meanwhile, in Korea, reflecting these trends, revised bills of the Framework Act on National Informatization and the Discrimination Disability Act have been recently approved. The main contents of the revised bills are that disabled users are allowed to access and use services on an equal basis with non-disabled users. Thus, it is evaluated that the discrimination against the disabled users be abolished in the use of unmanned terminals.

However, as the automation level of unmanned devices gradually increases and the range of services that can be replaced by the unmanned devices expands, the unmanned devices tend to be actively introduced in stores and public places. In contrast to the above tendency, it is still hardly difficult for the information vulnerable users to access to the unmanned devices, and the unmanned devices still continue to be a barrier to the aforementioned information vulnerable users as the unmanned devices are operated on the premise that the users are well-acquainted with the usage of the unmanned device.

In particular, visually impaired users can recognize information provided from the unmanned device or the like by using an auditory signal or by reading braille information, but such braille-based information and voice-based information are generally provided independently without correlation with each other, and thus it is difficult for the visually impaired users to obtain information efficiently.

The background art of the disclosure is disclosed in Korean Patent Publication No. 10-2022-0116859.

### SUMMARY

The disclosure is directed to providing an apparatus and method for providing complex information including braille information and voice information, capable of providing predetermined information, which is output to a user in a complex form of the braille information and the voice information, by linking and outputting the voice information to the braille information in consideration of the analysis result of a reading pattern of a visually impaired user for the braille information.

However, the technical problems to be achieved by embodiments of the disclosure are not limited to the technical problems as described above, and other technical problems may exist.

According to an aspect of an embodiment, there is provided a method of providing complex information including braille information and voice information, the method including deriving analysis data associated with a reading pattern of a user for braille information, and outputting voice information corresponding to the braille information on the basis of the analysis data.

In an embodiment, the analysis data may include at least one of reading completion information or reading speed information of the user for the braille information.

In an embodiment, the outputting of the voice information may include determining a time point, at which the voice information corresponding to a content on which the user has completed braille reading is output among the target information corresponding to the braille information, on the basis of the reading completion information.

In an embodiment, the outputting of the voice information may include determining a compression level for the voice information on the basis of information on a length of the content on which the user has completed the braille reading.

In an embodiment, the outputting of the voice information may include determining an output speed of the voice information on the basis of the reading speed information.

According to an aspect of another embodiment, there is provided a method of providing complex information including braille information and voice information, the method including obtaining braille information and voice information corresponding to target information, displaying the braille Information, deriving analysis data associated with a reading pattern of a user for the braille information, and outputting the voice information on the basis of the analysis data.

In an embodiment, in the outputting of the voice information, the voice information including a content corresponding to braille information that has not been read by the user among the displayed braille information may be output.

In an embodiment, the target information may include map information for a predetermined space.

In an embodiment, in the outputting of the voice information, when the user completes the reading of the braille information associated with a major object whose type is preset and included in the map information, information on the major object may be output as the voice information.

According to an aspect of another embodiment, there is provided an apparatus for providing complex information including braille information and voice information, the apparatus including a reading analysis unit configured to derive analysis data associated with a reading pattern of a user for braille information, and a voice control unit configured to output voice information corresponding to the braille information on the basis of the analysis data.

In an embodiment, the analysis data may include at least one of reading completion information or reading speed information of the user for the braille information.

In an embodiment, the voice control unit may determine a time point, at which the voice information corresponding to a content on which the user has completed braille reading is output among the target information corresponding to the braille information, on the basis of the reading completion information.

In an embodiment, the voice control unit may determine a compression level for the voice information on the basis of information on a length of the content on which the user has completed the braille reading.

In an embodiment, the voice control unit may determine an output speed of the voice information on the basis of the reading speed information.

According to an aspect of another embodiment, there is provided an apparatus for providing complex information including braille information and voice information, the apparatus including a data obtaining unit configured to obtain braille information and voice information corresponding to target information, a braille module control unit configured to display the braille information, a reading analysis unit configured to derive analysis data associated with a reading pattern of a user for the braille information, and a voice control unit configured to output the voice information on the basis of the analysis data.

In an embodiment, the voice control unit may output the voice information including a content corresponding to braille information that has not been read by the user among the displayed braille information.

In an embodiment, the target information may include map information for a predetermined space, and the voice control unit may output information on a major object as the voice information when the user completes the reading of the braille information associated with the major object whose type is preset and included in the map information.

The above-described means for solving problems are merely illustrative, and should not be construed as limiting the disclosure. In an embodiment to the exemplary embodiments described above, additional embodiments may exist in the drawings and detailed description of disclosure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration view of a complex information providing system according to an embodiment of the disclosure;

FIG. 2 is a conceptual view for describing a process of providing target information including map information for a predetermined space by linking braille information and voice information;

FIG. 3 is a view illustrating a braille cell module provided in an information terminal;

FIG. 4 is a schematic configuration view of an apparatus for providing complex information including braille information and voice information according to an embodiment of the disclosure;

FIG. 5 is an operation flowchart illustrating a method of providing complex information including braille information and voice information according to a first embodiment of the disclosure; and

FIG. 6 is an operation flowchart illustrating a method of providing complex information including braille information and voice information according to a second embodiment of the disclosure.

### DETAILED DESCRIPTION

Hereinafter, embodiments of the disclosure will be described in detail with references to the accompanying drawings in such a manner that those of ordinary skill in the art to which the disclosure pertains can easily implement them. However, the disclosure may be implemented in several different forms and is not limited to the embodiments described herein. In an embodiment, in order to clearly explain the disclosure in the drawings, portions irrelevant to the descriptions are omitted, and similar reference numerals are attached to similar portions throughout the specification.

Throughout this specification, when a part is “connected” with another part, it is not only “directly connected” but also “electrically connected”, or “indirectly connected” with another element interposed therebetween.

Throughout this specification, when it is said that a member is located “on”, “on an upper portion of”, “on a top of”, “under”, “on a lower portion of”, and “on a bottom of” another member, this means that a member is located on the other member. It includes not only the case where they are in contact, but also the case where another member exists between two members.

Throughout this specification, when a portion or a part “includes” a component or an element, it means that other components or elements may be further included, rather than excluding other components, unless otherwise stated.

The disclosure relates to an apparatus and method for providing complex information including braille information and voice information.

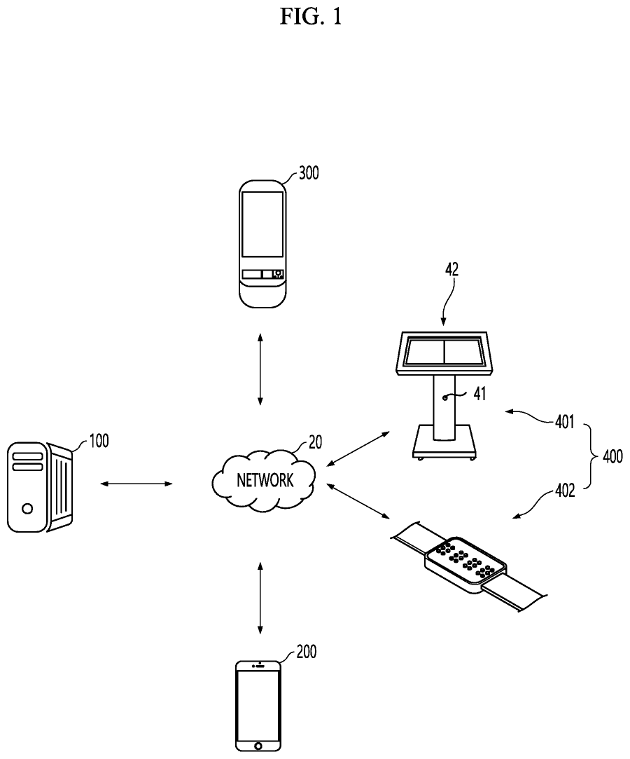

FIG. 1 is a schematic configuration view of a complex information providing system according to an embodiment of the disclosure.

Referring to FIG. 1, a complex information providing system 10 according to an embodiment of the disclosure may include an apparatus 100 for providing complex information including braille information and voice information according to an embodiment of the disclosure (hereinafter, referred to as a “complex information providing apparatus 100”), a user terminal 200, an information terminal 300, and a braille output device 400.

The complex information providing apparatus 100, the user terminal 200, the information terminal 300, and the braille output device 400 may communicate with each other via a network 20. The network 20 refers to a connection structure which enables information to is be exchanged between each node, such as terminals and servers. Examples of the network 20 may include a 3rd Generation Partnership Project (3GPP) network, Long Term Evolution (LTE) network, 5G network, World Interoperability for Microwave Access (WIMAX) network, Internet, Local Area Network (LAN), Wireless Local Area Network (Wireless LAN), Wide Area Network (WAN), Personal Area Network (PAN), a wifi network, a Bluetooth network, a satellite broadcasting network, an analog broadcasting network, a Digital Multimedia Broadcasting (DMB) network, or the like. However, the network 20 is not limited to those examples described above.

The user terminal 200 may include any type of wireless communication device, e.g., a smartphone, a smart pad, a tablet PC, and the like, and terminals for PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet).

In an embodiment, the information terminal 300 may be installed in the target space for the purpose of providing the user with route information for destinations, such as major facilities (toilets, elevators, escalators, or the like), stores (shops), and specific positions, or the like in the target space. However, the information terminal 200 is not limited to those described above, and may also be installed for the purpose of providing the user (passerby) with information on the target space or various types of information that is not limited to the target space. In an embodiment, in the description of the embodiment of the disclosure, the information terminal 300 may be a concept that broadly includes an unmanned device, a kiosk, a digital signage, and the like.

In an embodiment, in the description of the embodiment of the disclosure, the braille output device 400 may include a first type braille device 401, which is manufactured to output fixed braille information, and a second type braille device 402 for outputting non-fixed and variable braille information, for example, for outputting information corresponding to a user's search input or outputting information corresponding to information provided from the user terminal 200 through interworking with the user terminal 200.

More particularly, when an example is made to aid understanding, the first type braille device 401 may include a tactile map or the like that is provided in an entrance of a predetermined target space visited by a user to provide map information on the target space, and the second type braille device 402 may include a braille watch, a braille pad, or the like in which a display including a plurality of braille protrusion members is provided.

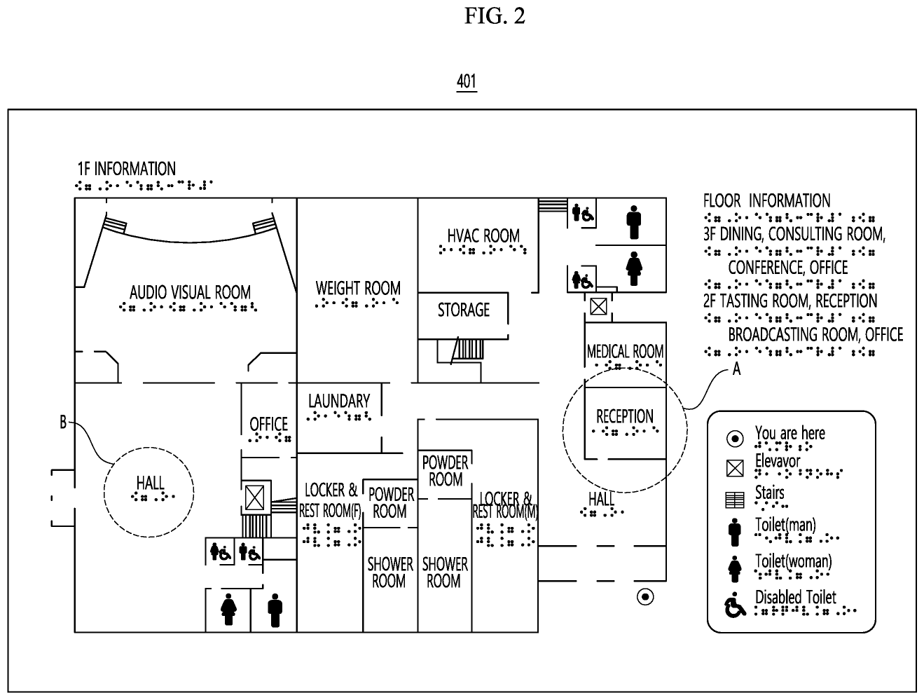

In an embodiment, referring to FIG. 1 and FIG. 2 to be described below, the first type braille device 401 may include a first output device 41 for outputting voice information and a second output device 42 in which braille protrusion members for displaying braille information are disposed.

In an embodiment, according to an embodiment of the disclosure, the second type braille device 402 may include a braille cell module 310 provided in the information terminal 300 with which the user interacts.

For reference, in relation to the embodiment of the disclosure, the ‘target space’ mainly means a multi-use facility or space used by a large number of people, such as subway stations, public transportation platforms, train stations, airports, shopping malls, department stores, parks, movie theaters, schools, stadiums, gyms, public institutions, or the like. However, the target space is not limited to those described above.

Hereinafter, a complex information providing process, which is associated with the first type braille device 401, according to a first embodiment of the disclosure will be described first.

The complex information providing apparatus 100 may derive analysis data associated with a pattern by which the user reads the braille information displayed by the first type braille device 401. Particularly, the complex information providing apparatus 100 may derive analysis data including at least one of user's read start information, reading completion information, and reading speed information for the braille information displayed by the first type braille device 401.

For example, the complex information providing apparatus 100 may detect that a user intends to start reading braille information by detecting motions of the corresponding user, such as, reaching the first type braille device 401 and placing a finger on the second output device 42 on which the braille protrusion members are disposed. In this regard, according to an embodiment of the disclosure, the complex information providing apparatus 100 controls the first output device 41 of the first type braille device 401 to output a voice (e.g., voice guidance with content such as “when braille reading is completed, the read content will be output as voice guidance”) including guidance information on the basis of the read start information of the user, and the guidance information indicates that the corresponding voice information is subsequently output according to the reading of the braille information.

In an embodiment, the complex information providing apparatus 100 may detect information (reading completion information) on a range of braille information that has been read by the user among the braille information displayed through the first type braille device 401, and information (reading speed information) on a speed at which the user reads the braille information (e.g., a moving speed of the finger or the like), on the basis of data on a pressure applied to each of the braille protrusion members included in the second output device 42 and analysis data on whether the user's finger is in contact with each of the braille protrusion members, which is reflected in the image data captured by the second output device 42.

In an embodiment, the complex information providing apparatus 100 may determine a time point, at which the voice information corresponding to a content on which the user has completed the braille reading is output among the target information corresponding to the braille information, on the basis of the reading completion information. For example, the complex information providing apparatus 100 may detect a time point, at which the operation of continuously reading the braille protrusion members by using the user's finger is completed, on the basis of the reading completion information, and may control the first output device 41 of the first type braille device 401 to output the contents of the target information, which are read by the user until the corresponding time point, in the form of voice information after the operation of reading is completed.

In this regard, the complex information providing apparatus 100 may recognize a time point, at which the user has completed the continuous read operation for at least a portion of the braille information, on the basis of a time series pattern, and the time series pattern may be obtained using data on pressure applied to each of the braille protrusion members included in the second output device 42, and analysis data on whether the user's finger is in contact with each of the braille protrusion members reflected in the image data captured by the second output device 42. When an example is made to aid understanding, when the user reads the second output device 42, which includes the braille protrusion members consist of a total of three columns, in units of one column, the complex information providing apparatus 100 may operate to identify a time point at which the reading of one column of braille information is completed and output the target information corresponding to the corresponding column (the column in which the user has completed the braille-based reading) in the form of voice information.

In an embodiment, the complex information providing apparatus 100 may determine a compression level for the voice information on the basis of information on a length of the content on which the user has completed the braille reading. For example, when the user continuously reads a relatively large amount of braille information at a time (e.g., when the target information corresponding to the read braille information is treated as text, and a text length is greater than or equal to a preset number of characters, or the like), the complex information providing apparatus 100 may output voice information for the target information corresponding to the content, on which the user has completed the braille reading, in a compressed (summarized) form. In this case, the voice information in the form in which the target information is compressed from the original state may be defined in advance on the basis of the fixed information provided through the first type braille device 401.

In an embodiment, the complex information providing apparatus 100 may determine an output speed of the voice information on the basis of the reading speed information. For example, on the basis of the analysis data, the complex information providing apparatus 100 may control the first type braille device 401 so that the voice information is output at a relatively high speed as a user's braille information reading speed is increased, and in contrast, the complex information providing apparatus 100 may control the first type braille device 401 so that the voice information is output at a relatively low speed as the user's braille information reading speed is reduced. At this point, when it is determined that the user's reading speed is greater than or equal to a preset threshold speed, the complex information providing apparatus 100 may control to compress and output the voice information for the target information instead of increasing the output speed of the voice information.

FIG. 2 is a conceptual view for describing a process of providing target information including map information for a predetermined space by linking braille information and voice information.

Referring to FIG. 2, the target information provided through the braille output device 400 may include map information for a predetermined space. In this regard, when the user completes the reading of the braille information associated with major objects whose types are preset and included in the map information, the complex information providing apparatus 100 may output the information on the major objects as voice information. In an example embodiment, when the user completes the braille reading of “RECEPTION” (see “A” in FIG. 2) or “HALL” (see “B” in FIG. 2), which is a major object preset to correspond to the map information shown in FIG. 2, the information (an object name, operating hours, standard information, door information, congestion information, or the like) related to the corresponding object may be subsequently output in the form of voice information.

In still another example, when it is determined that the user has completed the reading process in a state in which the user has not completed the braille reading of the major object for the target space, on the basis of the reading completion information among the analysis data, the complex information providing apparatus 100 may operate to output information on the major object, for which the reading is missing, as voice information. For example, when it is determined that the corresponding user completes the reading process in a state in which the user does not complete the braille reading of “RECEPTION” (see “A” in FIG. 2) or “HALL” (see “B” in FIG. 2), which is a major object preset to correspond to the map information shown in FIG. 2, the corresponding user may be lead to obtain information on the missing major object by outputting information indicating that the reading of the object has not been completed and position (relative position) information of the object on the braille-based map, in the form of voice information.

Meanwhile, according to an embodiment of the disclosure, the major objects reflected on the map information may be set on the basis of a user's search history stored in the user terminal 200.

In this regard, in the case of a visually impaired user or the like, as the visually impaired user has much difficulties in walking outdoors compared to a non-disabled user, and thus, has a tendency to search in advance information on a particular destination (route guide, information by floor inside a building, indoor facility information, or the like) by using the user terminal 200 such as a smart phone before leaving for the journey, the complex information providing apparatus 100 may search for meaningful prior search data from the user terminal 200 possessed by the user interacting with the braille output device 400 and may select objects (major spaces) corresponding to the searched prior search data as the major objects, so that the targeted customized information can be provided through the braille output device 400 so as not to be omitted to the user in order for the user to utilize the results previously searched through the user terminal 200 or the like.

In an example embodiment, the prior search data may broadly include web page access history (URL information or the like) obtainable by the user terminal 200, text data such as online search terms, image data, voice data, messenger, SNS data, user log, or the like.

In an embodiment, the providing of the guidance data for the object matching the prior search data may include the example followings: when there is a search history that a particular store (shop) located in the target space to which the braille output device 400 is installed is searched by the user terminal 200, the business information of the corresponding store (shop), the route information for reaching the corresponding store (shop), and the like are provided in the form of voice information by the braille output device 400 even if the braille information-based reading for the object is missing, so that the user can obtain the information without having to read the braille information.

In this regard, the complex information providing apparatus 100 may include a user log (searched information) analyzer for matching information corresponding to the prior search data. For example, the user log analyzer may include a keyword extraction function based on the text mining. In another example, the user log analyzer may include an artificial intelligence model (e.g., an artificial intelligence model based on a convolutional neural network (CNN) including an image analysis or an image sorting function.

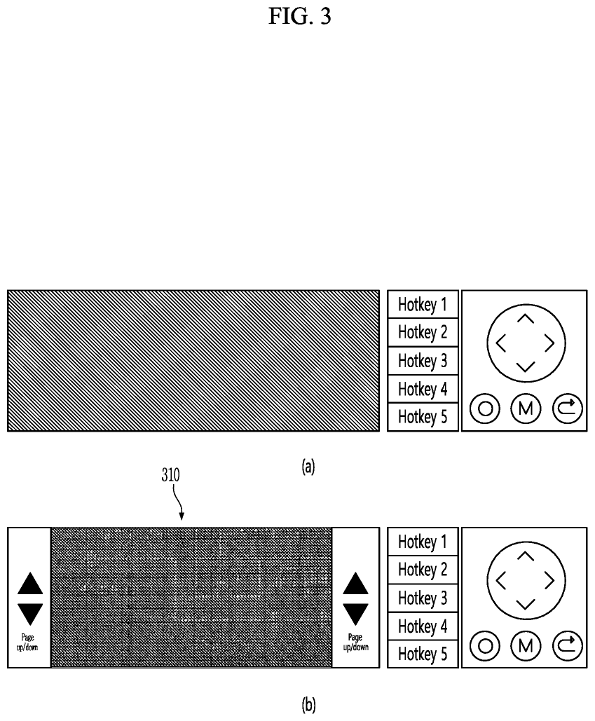

FIG. 3 is a view illustrating the braille cell module provided in the information terminal.

Referring to FIG. 3, the braille cell module 310 may be placed in a locked state (the state shown in FIG. 3A) by a predefined locker (e.g., a cover member that restricts an access to the braille cell module 310 in a closed state, or the like) so that a plurality of braille protrusions provided in the braille cell module 310 are prevented from being contaminated and damaged by preventing the braille cell module 310 from being used by users other than the visually impaired user, and the locked state may be selectively released (the state shown in FIG. 3B) only when the visually impaired user intends to use the information terminal 300. Accordingly, the complex information providing apparatus 100 may be selectively operated when the locker of the braille cell module 310 is released by determining that the corresponding user corresponds to a visually impaired user on the basis of disability information of the corresponding user.

For example, when the above-described locker is released because it is determined that the visually impaired user is located away from the information terminal 300 by a distance within a preset distance range on the basis of position information of the user, or it is determined that an expected arrival time of the user to the information terminal 300 calculated on the basis of the position information of the user is within a preset time range, the complex information providing apparatus 100 may operate to obtain the target information provided through the information terminal 300 and synchronize braille information with voice information.

According to a second embodiment of the disclosure, the complex information providing apparatus 100 may obtain the braille information and voice information corresponding to the provided target information by using the second type braille device 402.

In an embodiment, the complex information providing apparatus 100 may display the braille information corresponding to the obtained target information through the second type braille device 402, derive analysis data associated with a reading pattern of the user for the displayed braille information, and output voice information according to the derived analysis data, and the content described above with respect to the method of providing the complex information using the first type braille device 401 according to the first embodiment of the disclosure can be equally applied to a process of obtaining analysis data associated with such reading pattern of the user for the braille information, and a method of outputting voice information according to the analysis data.

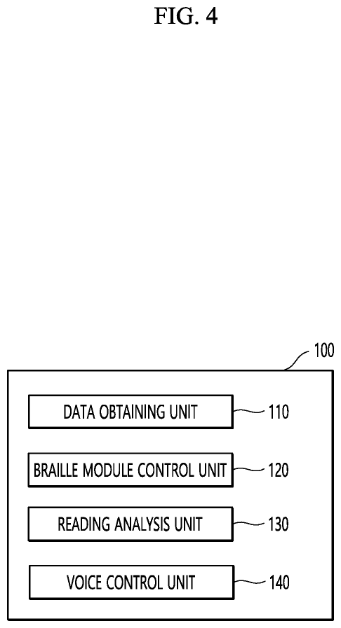

FIG. 4 is a schematic configuration view of an apparatus for providing complex information including braille information and voice information according to an embodiment of the disclosure.

Referring to FIG. 4, the complex information providing apparatus 100 may include a data obtaining unit 110, a braille module control unit 120, a reading analysis unit 130, and a voice control unit 140.

The data obtaining unit 110 may obtain braille information and voice information corresponding to target information. In an example embodiment, the target information may include map information for a predetermined space.

The braille module control unit 120 may display the braille information obtained in operation S21.

The reading analysis unit 130 may derive analysis data associated with a user's reading pattern for the braille information. Particularly, the reading analysis unit 130 may obtain the analysis data including at least one of user's reading completion information and reading speed information for the braille information.

The voice control unit 140 may output the voice information on the basis of the analysis data.

Particularly, the voice control unit 140 may determine a time point, at which the voice information corresponding to a content on which the user has completed the braille reading is output among the target information corresponding to the braille information, on the basis of the reading completion information. In an embodiment, the voice control unit 140 may determine an output speed of the voice information on the basis of the reading speed information.

In an embodiment, the voice control unit 140 may determine a compression level for the output voice information on the basis of information on a length of the content on which the user has completed the braille reading.

According to an embodiment of the disclosure, the voice control unit 140 may output voice information including a content corresponding to braille information that has not been read by the user among the displayed braille information.

According to an embodiment of the disclosure, when the user completes the reading of the braille information associated with major objects whose types are preset and included in the map information, the voice control unit 140 may output the information on the major objects as voice information.

Hereinafter, the operation flow of the disclosure will be briefly described based on the details given above.

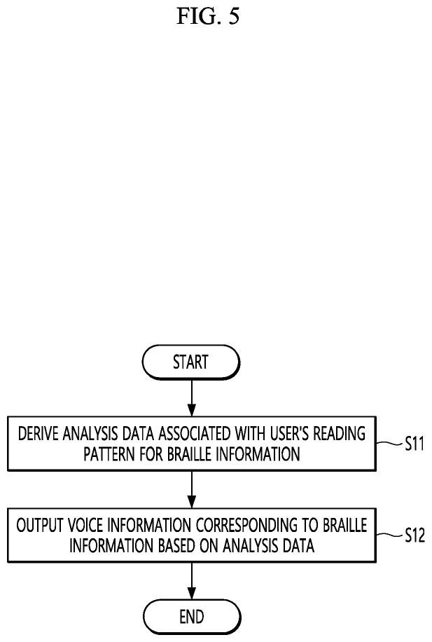

FIG. 5 is an operation flowchart illustrating a method of providing complex information including braille information and voice information according to a first embodiment of the disclosure.

The method of providing complex information including braille information and voice information according to the first embodiment of the disclosure illustrated in FIG. 5 may be performed by the above-described complex information providing apparatus 100. Thus, although omitted below, the contents described with respect to the complex information providing apparatus 100 may be equally applied to a description of the method of providing complex information including braille information and voice information according to the first embodiment of the disclosure.

Referring to FIG. 5, in operation S11, the reading analysis unit 130 may derive analysis data associated with user's reading pattern for braille information. Particularly, in operation S11, the reading analysis unit 130 may obtain the analysis data including at least one of user's reading completion information and reading speed information for the braille information.

Next, in operation S12, the voice control unit 140 may output voice information corresponding to the braille information on the basis of the analysis data derived in operation S11.

According to an embodiment of the disclosure, in operation S12, the voice control unit 140 may determine a time point, at which the voice information corresponding to a content on which the user has completed the braille reading is output among the target information corresponding to the braille information, on the basis of the reading completion information.

In an embodiment, according to an embodiment of the disclosure, in operation S12, the voice control unit 140 may determine a compression level for the output voice information on the basis of information on a length of the content on which the user has completed the braille reading.

In an embodiment, according to an embodiment of the disclosure, in operation S12, the voice control unit 140 may determine an output speed of the voice information on the basis of the reading speed information.

In the descriptions given above, operations S11 to S12 may be further divided into additional operations or be combined into fewer operations, according to an embodiment of the disclosure. In an embodiment, some operations may be omitted if necessary, and the order between the operations may be changed.

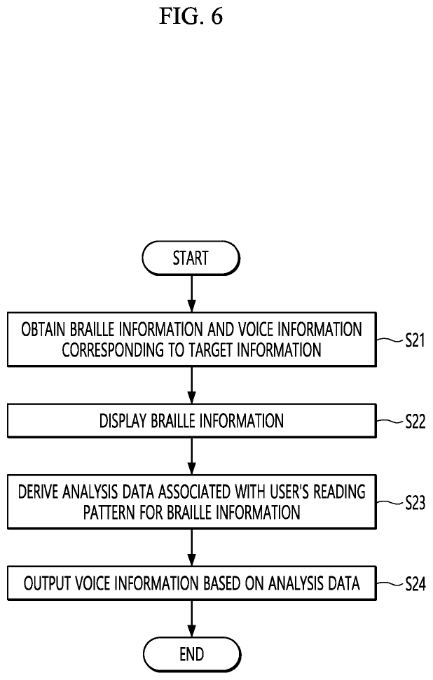

FIG. 6 is an operation flowchart illustrating a method of providing complex information including braille information and voice information according to a second embodiment of the disclosure.

The method of providing complex information including braille information and voice information according to the second embodiment of the disclosure illustrated in FIG. 6 may be performed by the above-described complex information providing apparatus 100. Thus, although omitted below, the contents described with respect to the complex information providing apparatus 100 may be equally applied to a description of the method of providing complex information including braille information and voice information according to the second embodiment of the disclosure.

Referring to FIG. 6, in operation S21, the data obtaining unit 110 may obtain braille information and voice information corresponding to target information. For example, the target information may include map information for a predetermined space.

Next, in operation S22, the braille module control unit 120 may display the braille information obtained in operation S21.

Next, in operation S23, the reading analysis unit 130 may derive analysis data associated with a user's reading pattern for the braille information.

Next, in operation S24, the voice control unit 140 may output the voice information on the basis of the analysis data.

According to an embodiment of the disclosure, in operation S24, the voice control unit 140 may output voice information including a content corresponding to braille information that has not been read by the user among the displayed braille information.

According to an embodiment of the disclosure, in operation S24, when the user completes the reading of the braille information associated with major objects whose types are preset and included in the map information, the voice control unit 140 may output the information on the major objects as voice information.

In the descriptions given above, operations S21 to S24 may be further divided into additional operations or be combined into fewer operations, according to an embodiment of the disclosure. In an embodiment, some operations may be omitted if necessary, and the order between the operations may be changed.

The method of providing complex information including braille information and voice information according to an embodiment of the disclosure may be recorded in a computer-readable medium in the form of program instructions that can be executed by various computers. The computer-readable medium described above may include program instructions, data files, data structures, and the like which may be used alone or in combinations thereof. The program instructions recorded in the medium above described may include program instructions that are specially designed and configured only for the present disclosure and program instructions that are known and available to those skilled in the art of computer software. The computer-readable recording medium may include hardware devices specially configured to store and execute program instructions. Examples of the hardware devices may include magnetic media such as a hard disk, a floppy disk and a magnetic tape (Magnetic Media), optical media such as a CD-ROM and a DVD (Optical Media), and magneto-optical media (Magneto-optical Media) such as a floppy disk (Floptical Disk), a ROM, a RAM, and flash memory. Examples of the program instructions may include high-level language codes executed by a computer using an interpreter or the like as well as machine language codes such as those generated by a compiler. The hardware devices described above may be configured to operate as one or more software modules so as to perform the operations of the disclosure, and vice versa.

Also, the above-described method of providing complex information including braille information and voice information may be implemented in the form of a computer program or application that is stored on a recording medium and executed by a computer.

According to the above-described problem solving means of the disclosure, it is possible to provide an apparatus and method for providing complex information including braille information and voice information, capable of providing predetermined information, which is output to a user in a complex form of the braille information and voice information, by linking and outputting the voice information to the braille information in consideration of the analysis result of a reading pattern of a visually impaired user for the braille information.

According to the above-described problem solving means of the disclosure, it is possible to solve the problem that a user may be rather confused or have difficulty in understanding contents of guided information as voice guidance and braille guidance are provided without being synchronized with each other.

However, the effects obtainable from the disclosure are not limited to the above-described effects, and other effects may exist.

The foregoing descriptions of the disclosure described above are illustrative of example embodiments, and those of ordinary skill in the art to which the disclosure pertains will understand that it can be easily modified into other specific forms without changing the technical spirit or essential features of the disclosure. Therefore, it should be understood that the embodiments described above are illustrative in all respects and not restrictive. For example, each component described as a single type may be implemented in a distributed manner, and likewise components described as distributed may also be implemented in a combined form.

The scope of the disclosure is indicated by the following claims rather than the above detailed description, and all changes or modifications derived from the meaning and scope of the claims and their equivalent concepts should be construed as being included in the scope of the disclosure.

What is claimed is:

1. A method of providing complex information including braille information and voice information, the method comprising:
deriving analysis data associated with a reading pattern of a user for braille information; and
outputting voice information corresponding to the braille information on the basis of the analysis data.

2. The method of claim 1, wherein the analysis data comprises at least one of reading completion information or reading speed information of the user for the braille information.

3. The method of claim 2, wherein the outputting of the voice information includes determining a time point, at which the voice information corresponding to a content on which the user has completed braille reading is output among the target information corresponding to the braille information, on the basis of the reading completion information.

4. The method of claim 3, wherein the outputting of the voice information comprises determining a compression level for the voice information on the basis of information on a length of the content on which the user has completed the braille reading.

5. The method of claim 2, wherein the outputting of the voice information comprises determining an output speed of the voice information on the basis of the reading speed information.

6. A method of providing complex information including braille information and voice information, the method comprising:
obtaining braille information and voice information corresponding to target information;
displaying the braille information;
deriving analysis data associated with a reading pattern of a user for the braille information; and
outputting the voice information on the basis of the analysis data.

7. The method of claim 6, wherein
in the outputting of the voice information,
the voice information comprising a content corresponding to braille information that has not been read by the user among the displayed braille information is output.

8. The method of claim 6, wherein
the target information comprises map information for a predetermined space, and
in the outputting of the voice information,
when the user completes the reading of the braille information associated with a major object whose type is preset and included in the map information, information on the major object is output as the voice information.

9. An apparatus for providing complex information including braille information and voice information, the apparatus comprising:
a reading analysis unit configured to derive analysis data associated with a reading pattern of a user for braille information; and
a voice control unit configured to output voice information corresponding to the braille information on the basis of the analysis data.

10. The apparatus of claim 9, wherein
the analysis data comprises at least one of reading completion information or reading speed information of the user for the braille information, and
the voice control unit determines a time point, at which the voice information corresponding to a content on which the user has completed braille reading is output among the target information corresponding to the braille information, on the basis of the reading completion information.

11. The apparatus of claim 10, wherein the voice control unit determines a compression level for the voice information on the basis of information on a length of the content on which the user has completed the braille reading.

12. The apparatus of claim 10, wherein the voice control unit determines an output speed of the voice information on the basis of the reading speed information.

13. An apparatus for providing complex information including braille information and voice information, the apparatus comprising:
a data obtaining unit configured to obtain braille information and voice information corresponding to target information;
a braille module control unit configured to display the braille information;
a reading analysis unit configured to derive analysis data associated with a reading pattern of a user for the braille information; and
a voice control unit configured to output the voice information on the basis of the analysis data.

14. The apparatus of claim 13, wherein the voice control unit outputs the voice information comprising a content corresponding to braille information that has not been read by the user among the displayed braille information.

15. The apparatus of claim 13, wherein
the target information comprises map information for a predetermined space, and
the voice control unit outputs information on a major object as the voice information when the user completes the reading of the braille information associated with the major object whose type is preset and included in the map information.
